(19) United States
(12) Patent Application Publication
(10) Pub. No.: US 2008/0234083 A1
(43) Pub. Date: Sep. 25, 2008

(54) Tensioner

(76) Inventors: Casper Haenbeukers, Landgraaf (NL); Michael Kamm, Stolberg (DE)

Correspondence Address: THE GATES CORPORATION, IP LAW DEPT. 10-A3, 1551 WEWATTA STREET, DENVER, CO, 80202, US

(21) Appl. No.: 11/726,792

(22) Filed: Mar. 23, 2007

(51) Int. Cl. F16H 7/12

(52) U.S. Cl. 474/135

(57) ABSTRACT

A tensioner comprising a shaft (10) having a shaft portion (12) engagable with a mounting surface, a pivot arm (50) pivotally engaged with the shaft about an axis A-A, a plate (70) fixedly attached to the shaft, the plate disposed on an end of the shaft opposite the shaft portion, a torsion spring (60) engaged between the pivot arm and the plate for biasing the pivot arm, the torsion spring disposed opposite the shaft portion and immediately adjacent the plate, a pulley (40) journalled to the pivot arm, the center of rotation of the pivot arm (A-A) disposed eccentrically from the center of rotation (B-B) of the plate, the pivot arm having a tab (55) which cooperates with a portion (74) on the plate to indicate a relative position of the pivot arm with respect to the plate during installation, and a tool receiving portion (75) on the plate for rotationally adjusting the plate during installation.

### FIELD OF THE INVENTION

The invention relates to a tensioner having an eccentrically adjustable top plate and fixedly connected shaft, and having a torsion spring disposed between the top plate and the pivot arm opposite a mounting surface.

### BACKGROUND OF THE INVENTION

Tensioners are used to apply a preload to a belt drive system. This assures proper operating load for the belt as it transmits power from a driver sprocket or pulley to a driven sprocket or pulley.

The prior art double eccentric tensioners comprise a larger envelop because they require an orientation feature on the base engaged with the engine block in order to properly align the tensioner on the engine.

Representative of the art is U.S. Pat. No. 6,464,604 which discloses a tensioner for tensioning engine driven driving elements, such as belts or chains, is disclosed. In accordance with one aspect of the invention, the tensioner is initially installed with the pivot structure spaced past the perpendicular angular position thereof. In accordance with another aspect of the invention, the tension required to move the pivot structure to the end of its range of angular positions is at least 75% more than at the hot engine angular position thereof. In accordance with another aspect of the invention, the tensioner has a stop at the maximum travel position thereof and the tension required to move the pivot structure to its maximum travel position is at least 75% more than at the hot engine angular position thereof. In accordance with a still further aspect of the invention, the tension required to move the pivot structure to a potential tooth skip angular position is greater than the maximum tension the engine is capable of creating.

What is needed is a tensioner having an eccentrically adjustable top plate and fixedly connected shaft, and having a torsion spring disposed between the top plate and the pivot arm opposite a mounting surface. The present invention meets this need.

### SUMMARY OF THE INVENTION

The primary aspect of the invention is to provide a tensioner having an eccentrically adjustable top plate and fixedly connected shaft, and having a torsion spring disposed between the top plate and the pivot arm opposite a mounting surface.

Other aspects of the invention will be pointed out or made obvious by the following description of the invention and the accompanying drawings.

The invention comprises a tensioner comprising a shaft having a shaft portion engagable with a mounting surface, a pivot arm pivotally engaged with the shaft about an axis, a plate fixedly attached to the shaft, the plate disposed on an end of the shaft opposite the shaft portion, a torsion spring engaged between the pivot arm and the plate for biasing the pivot arm, the torsion spring disposed opposite the shaft portion and immediately adjacent the plate, a pulley journalled to the pivot arm, the center of rotation of the pivot arm disposed eccentrically from the center of rotation of the plate, the pivot arm having a tab which cooperates with a portion on the plate to indicate a relative position of the pivot arm with respect to the plate during installation, and a tool receiving portion on the plate for rotationally adjusting the plate during installation.

### BRIEF DESCRIPTION OF THE DRAWINGS

The accompanying drawings, which are incorporated in and form a part of the specification, illustrate preferred embodiments of the present invention, and together with a description, serve to explain the principles of the invention.

FIG. 1 is an exploded view of the inventive tensioner.

FIG. 2 is a top perspective view of the sleeve and top base plate assembly.

FIG. 3 is a bottom perspective view of the tensioner pivot arm.

FIG. 4 is a top perspective view of the pivot arm on the shaft.

FIG. 5 is a top perspective view of the top plate and pivot arm.

FIG. 6 is a top perspective view of the tensioner.

FIG. 7 is a detail of FIG. 6.

FIG. 8 is a side view detail of FIG. 7.

FIG. 9 is a side view of the tensioner.

FIG. 10(a) is a schematic diagram of the installation principle.

FIG. 10(b) is a schematic diagram of the installation principle.

FIG. 10(c) is a schematic diagram of the installation principle.

FIG. 10(d) is a schematic diagram of the installation principle.

FIG. 10(e) is a schematic diagram of the installation principle.

### DETAILED DESCRIPTION OF THE PREFERRED EMBODIMENT

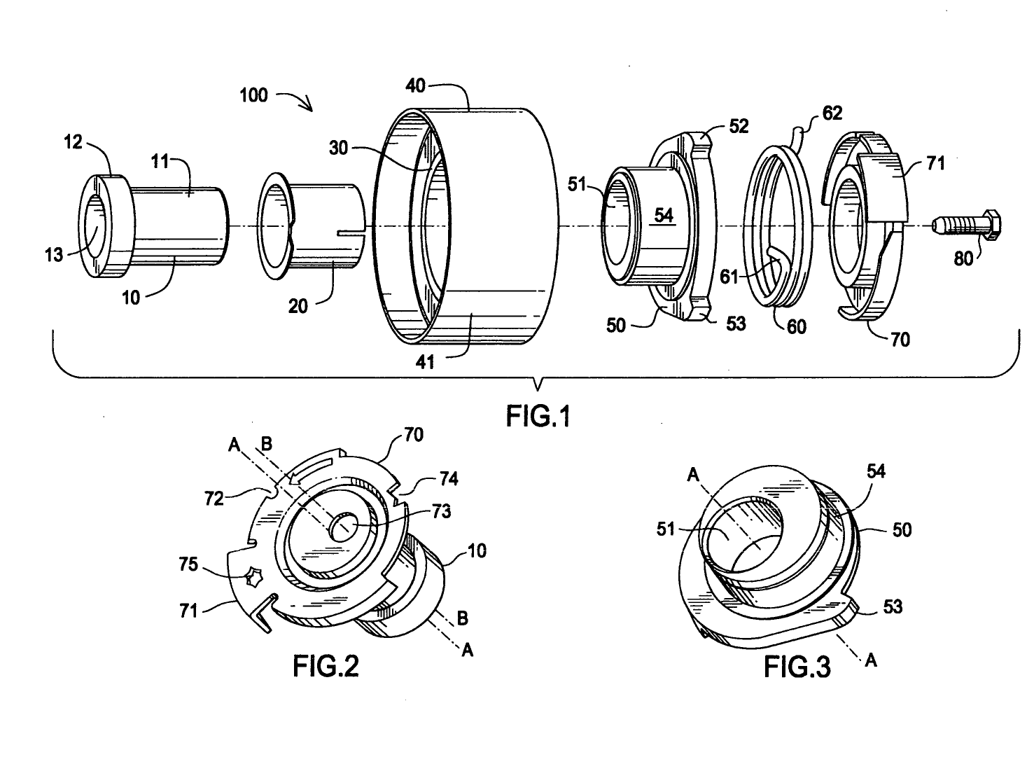

FIG. 1 is an exploded view of the inventive tensioner. Tensioner 100 comprises shaft 10 fixedly connected to base 70. Shaft 10 does not rotate. Portion 12 engages a mounting surface (not shown) as well as acts to hold the components together between portion 12 and top plate 70.

Bushing 20 acts as a friction bearing and is disposed between the outer surface 11 of shaft 10 and the bore surface 51 of pivot arm 50.

Bearing 30 is engaged with pivot arm 50. Pulley 40 is engaged with bearing 30. Bearing 30 may comprise any suitable type including ball bearing, needle bearing and the like. In this embodiment bearing 30 is a ball bearing having inner and outer races known in the art. Pulley 40 rotates about bearing 30 on the bearing outer race.

Pulley 40 may comprise steel or molded plastic. Pulley 40 may comprise either a flat or toothed belt bearing surface 41.

Torsion spring 60 is disposed between pivot arm 50 and top plate 70, opposite the shaft portion 12 on shaft 10. Namely, torsion spring 60 is disposed opposite the shaft portion and immediately adjacent top plate 70. End 61 engages pivot arm 50. End 62 engages top plate 70. Torsion spring 60 biases pivot arm 50 so as to apply a torque load to a belt (not shown). The belt engages pulley 40.

The tensioner does not include an indexing base known in the art, for example see extension (70) disclosed in U.S. Pat. No. 6,149,542. Absence of the indexing base allows the inventive tensioner to be placed on an engine without need for indexing on the engine, namely, it can be placed in any position. This also eliminates the need for making provision on the engine for indexing, for example such as slot S disclosed in U.S. Pat. No. 6,149,542. This improvement is an advantage for the engine manufacturer.

Fastener 80 is used to secure the tensioner to a mounting surface such as a vehicle engine.

FIG. 2 is a top perspective view of the sleeve and top plate assembly. Top plate 70 comprises a stop 71 which extends axially in order to engage protrusions 52, 53 on pivot arm 50. Stop 71 limits the range of movement of pivot arm 50. End 62 is retained in slot 72 in top plate 70.

Hole 73, which aligns with axis B-B and comprises the eccentric feature of the tensioner, in top plate 70 receives a fastener (not shown) for securing the tensioner to a mounting surface. Hole 73 aligns with bore 13 in shaft 10 so that a fastener may be inserted there through. Pivot arm 50 pivots about axis A-A. Axis B-B is eccentrically disposed from axis A-A. During installation top plate 70 pivots about a fastener 80 on axis B-B, thereby eccentrically adjusting the tensioner.

Tool receiving portion 75 is used for engaging a tool (not shown) to top plate 70 for the purpose of adjusting the tensioner.

FIG. 3 is a bottom perspective view of the tensioner pivot arm. Surface 54 engages bearing 30. Surface 51 is eccentrically located with respect to surface 54. Surface 51 is coaxially aligned with surface 11. Pivot arm 50 pivots about axis A-A during operation. Protrusion 53 limits pivoting travel of pivot arm 50.

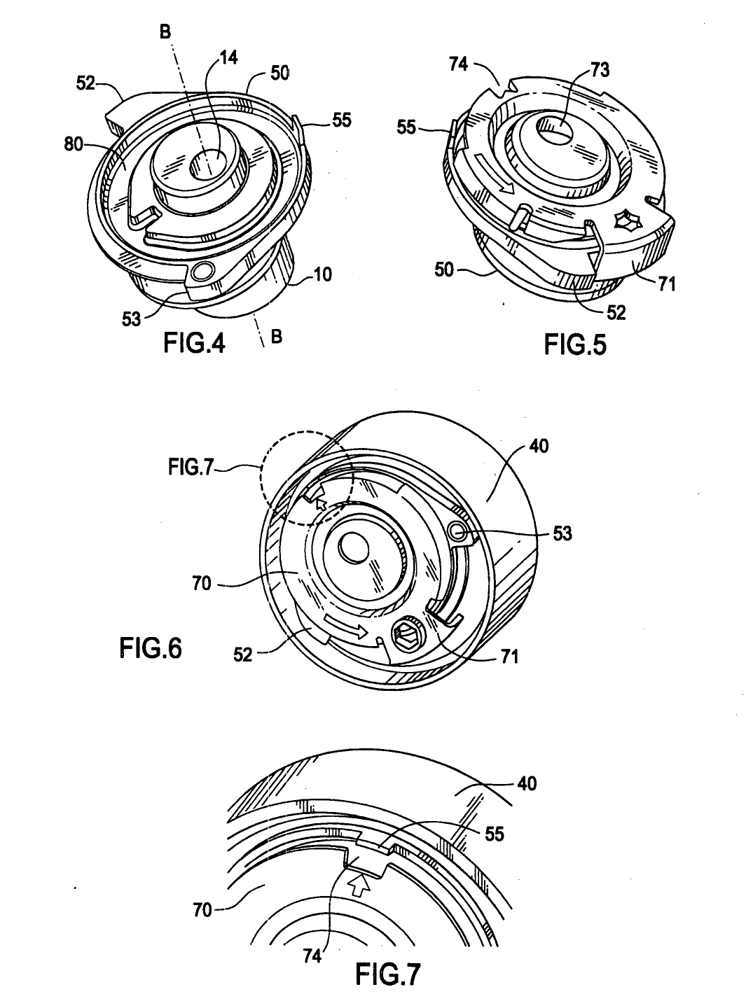

FIG. 4 is a top perspective view of the pivot arm on the shaft. Member 80 engages a coil of spring 30. Tab 55, (arm pointer) is a means of indicating position of and proper installation of pivot arm 50. Tab 55 cooperates with portion 74 (base indicator) in top plate 70 in order to indicate relative pivot arm position with respect to the top plate 70.

In this embodiment shaft 10 is not hollow with a bore 13 as shown in FIG. 1. Instead, hole 14 is disposed in a solid shaft and is eccentrically aligned with hole 73.

FIG. 5 is a top perspective view of the top plate and pivot arm. Protrusion 52 is shown engaged with stop 71. Protrusion 52 is also known as the ‘cold stop’. Tab 55 is not aligned with portion 74 for this pivot arm position.

FIG. 6 is a top perspective view of the tensioner. Stop 71 is disposed substantially between protrusions 52, 53. By being disposed on top of the tensioner, tab 55 and portion 74 are readily seen during installation and adjustment.

FIG. 7 is a detail of FIG. 6. Tab 55 is shown aligned with portion 74. In this configuration stop 71 is disposed nominally between protrusion 52 and 53. The range between protrusion 52 and 53, also referred to as the cold stop and hot stop respectively, allows the tensioner to pivot in order to maintain a relatively constant belt tension over engine temperature ranges, as well as providing means for compensation of dynamic behavior of the belt and belt drive during load swings.

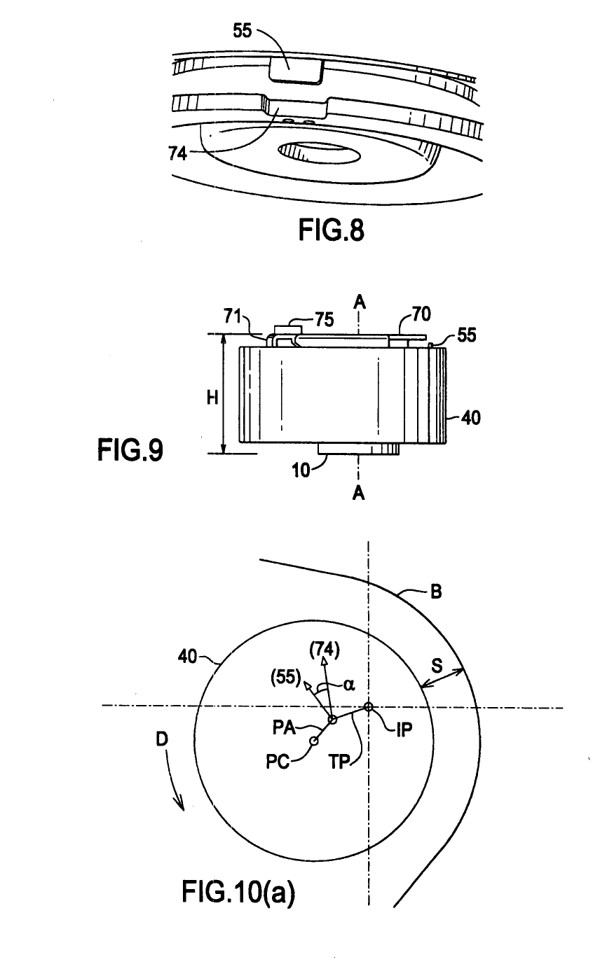

FIG. 8 is a side view detail of FIG. 7. Tab 55 is not coplanar (with respect to a plane normal to axis A-A, see FIG. 9) with portion 74 so that it does not interfere with movement of pivot arm 50.

FIG. 9 is a side view of the tensioner. Tool receiving portion 75 is used to turn shaft 10 and top plate 70 during installation. The tool (not shown) may comprise any well known wrench or ratchet tool. The inventive design also causes the profile or height of the tensioner (H) to be lower or thinner that prior art tensioners.

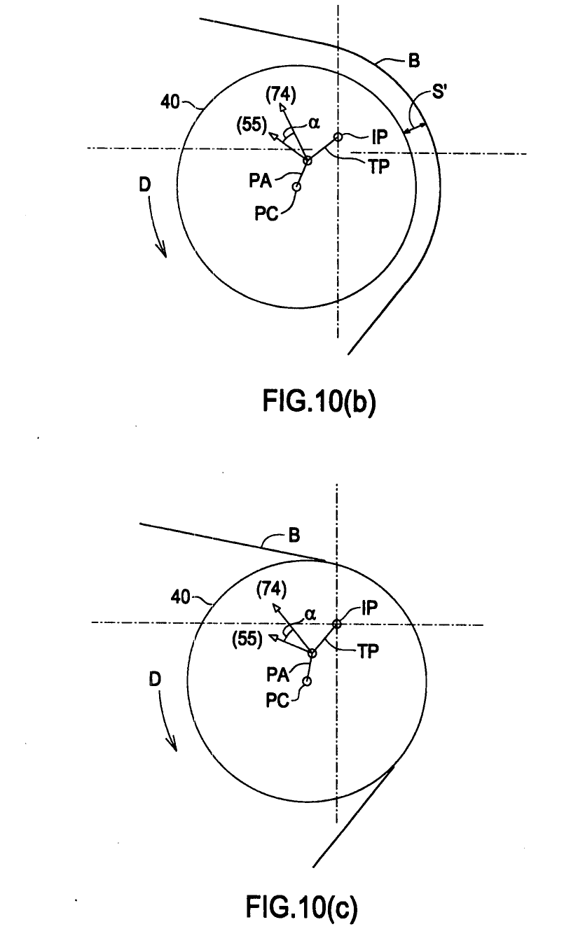

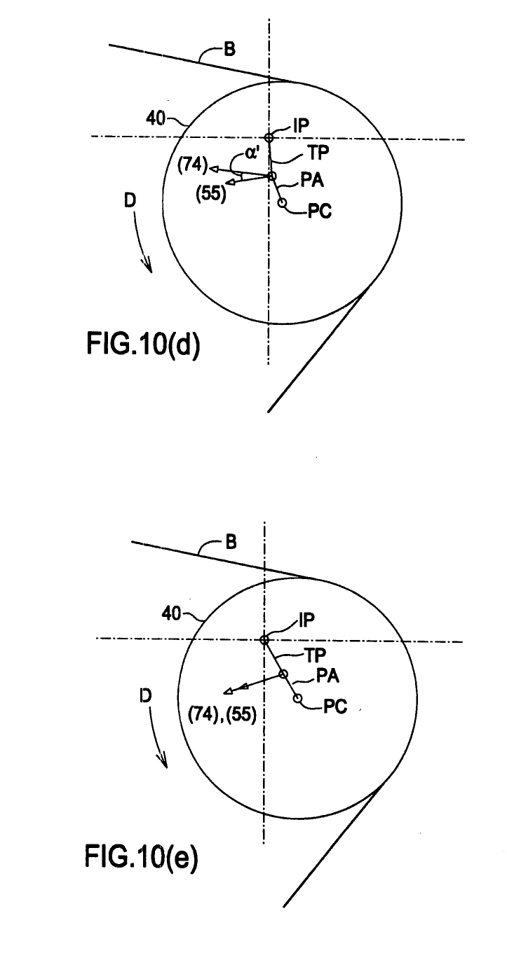

FIG. 10(a) is a schematic diagram of the installation principle. The fastener installation point (IP) is where the tensioner is bolted down to a mounting surface. The top plate 70 and shaft 10 rotate about point IP during installation, also referred to as axis B-B. The large circle is a representation of pulley 40. The center of rotation of pulley 40 is (PC), also referred to as axis A-A. The pivot arm 50 is represented by (PA). The top plate is represented by (TP). The relative direction to tab 55 is marked (55). The relative direction to portion 74 is marked (74). PA stays in fixed angular relation to (55) during installation. TP stays in fixed angular relation to (74) to during installation. During installation and adjustment the top plate 70 is turned in direction D using a tool inserted into tool receiving portion 75. Stop 71 is engaged with protrusion 52 (cold stop). FIG. 10(a) shows the tensioner prior to adjustment with no belt load and the protrusion 52 engaged with stop 71, see FIG. 5. A belt is marked B. An initial gap between the pulley 40 and the belt B is marked S. Tab 55 and portion 74 have an angular separation of a degrees since there is no belt load and stop 71 is engaged with protrusion 52.

FIG. 10(b) is a schematic diagram of the installation principle. In this figure top plate 70 has been turned about IP (axis B-B) in direction D, and the gap to belt B has decreased to S′. Angle α has not changed since belt B is not in contact with pulley 40.

FIG. 10(c) is a schematic diagram of the installation principle. Pulley 40 is just in contact with belt B (S→0) and so angle α has not been changed or decreased.

FIG. 10(d) is a schematic diagram of the installation principle. Top plate 70 has been partially rotated about axis B-B and angle α has decreased to angle α′. The decrease in angle α means that tab 55 and portion 74 are coming into alignment as top plate 70 is turned about axis B-B. In this figure the stop 71 has disengaged from the protrusion 52 (cold stop) and moved in the direction of the hot stop, namely, protrusion 53. In this figure the belt load is increasing as top plate 70 is rotated.

FIG. 10(e) is a schematic diagram of the installation principle. Top plate has been further rotated about axis B-B and angle α has closed (α→0°) so there is essentially little or no angular separation between tab 55 and portion 74, therefore they are aligned, see FIG. 7. As the top plate is being turned during installation, the spring torque and thereby belt load is increased by the torsion spring force. The tensioner is properly installed in this configuration. The spring force is equal to the belt load. The fastener 80 can then be torqued down to complete attaching the tensioner to a mounting surface.

Stop 71 is disposed substantially between protrusions 52, 53. Protrusion 53 is also called the “hot stop”.

Although a form of the invention has been described herein, it will be obvious to those skilled in the art that variations may be made in the construction and relation of parts without departing from the spirit and scope of the invention described herein.

We claim:

1. A tensioner comprising:
a shaft (10) having a shaft portion (12) engagable with a mounting surface;
a pivot arm (50) pivotally engaged with the shaft about an axis A-A;
a plate (70) fixedly attached to the shaft, the plate disposed on an end of the shaft opposite the shaft portion;
a torsion spring (60) engaged between the pivot arm and the plate for biasing the pivot arm, the torsion spring disposed opposite the shaft portion and immediately adjacent the plate;
a pulley (40) journalled to the pivot arm, the center of rotation of the pivot arm (A-A) disposed eccentrically from the center of rotation (B-B) of the plate;
the pivot arm having a tab (55) which cooperates with a portion (74) on the plate to indicate a relative position of the pivot arm with respect to the plate during installation; and
a tool receiving portion (75) on the plate for rotationally adjusting the plate during installation.

2. The tensioner as in claim 1 further comprising a stop (71) on the plate for limiting a pivot arm pivot range.

3. The tensioner as in claim 2 further comprising protrusions (52,53) on the pivot arm for cooperatively engaging the stop.

4. The tensioner as in claim 1 further comprising a friction bushing (20) between the shaft and pivot arm.

5. The tensioner as in claim 1 wherein the shaft comprises a bore (13) for receiving a fastener (80).

6. The tensioner as in claim 1 wherein the shaft comprises a hole (14) for receiving a fastener.
